(19) United States
(12) Patent Application Publication
(10) Pub. No.: US 2017/0346673 A1
(43) Pub. Date: Nov. 30, 2017

(54) IDENTIFYING WIRELESS SERVICE

(71) Applicant: NOKIA TECHNOLOGIES OY, Espoo (FI)

(72) Inventors: Jarkko Kneckt, Espoo (FI); Enrico-Henrik Rantala, Berkeley, CA (US); Mika Kasslin, Espoo (FI); Janne Marin, Espoo (FI); Olli Alanen, Vantaa (FI)

(73) Assignee: NOKIA TECHNOLOGIES OY, Espoo (FI)

(21) Appl. No.: 15/536,331

(22) PCT Filed: Dec. 15, 2014
(86) PCT No.: PCT/FI2014/050996

§ 371 Date: Jun. 15, 2017

(51) Int. Cl. H04L 29/12; H04L 29/08; H04W 48/16

(52) U.S. Cl. CPC H04L 29/12; H04W 48/16; H04L 29/08; H04L 61/6022; H04L 67/16

(57) ABSTRACT

This document discloses a solution where a frame transferred in a wireless network comprises a group address, and wherein the group address comprises a service identifier identifying a service provided in the wireless network. Apparatuses of the wireless network may employ the group address to identify the service.

### FIELD

The invention relates to the field of wireless networking and, particularly, to identifying a wireless service provided in a wireless network.

### BACKGROUND

With the increasing number of radio networking devices, variety of wireless services is also increasing. A local area network may be utilized to provide various local area services amongst radio networking devices. Available services may be published and discovered in a service discovery process.

### BRIEF DESCRIPTION

Some aspects of the invention are defined by the independent claims.

Embodiments of the invention are defined in the dependent claims.

### LIST OF DRAWINGS

Embodiments of the present invention are described below, by way of example only, with reference to the accompanying drawings, in which

FIG. 1 illustrates a wireless communication scenario to which embodiments of the invention may be applied;

FIG. 2 illustrates a process for identifying a service on a lower protocol layer and for filtering messages on the lower protocol layer according to some embodiments of the invention;

FIG. 3 illustrates a process for determining how to process an address field of a received frame according to an embodiment of the invention;

FIGS. 4 to 6 illustrate embodiments of a group address field of a frame according to some embodiments of the invention; and

FIG. 7 illustrates a block diagram of a structure of an apparatus according to an embodiment of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

A wireless communication scenario to which embodiments of the invention may be applied is illustrated in FIG. 1. FIG. 1 illustrates a plurality of wireless devices 100, 102, 104, 106, 108, 109 that form an ad hoc network. The ad hoc network may comply with neighbour awareness networking (NAN) principles described in greater detail below. The wireless devices may form a single network comprising one or more clusters of the same network, or the wireless devices may form two different wireless networks 110, 112. The wireless devices may employ physical layer and medium access control (MAC) layer that comply with wireless local area network (WLAN) specifications based on IEEE 802.11 but, in other embodiments, the wireless devices may support another wireless communication protocol as an alternative or in addition to the WLAN. In the WLAN specifications, a wireless network may be called a basic service set (BSS). While embodiments of the invention are described in the context of the IEEE 802.11, it should be appreciated that these or other embodiments of the invention may be applicable to wireless networks based on other specifications, e.g. WiMAX (Worldwide Interoperability for Microwave Access), UMTS LTE (Long-term Evolution for Universal Mobile Telecommunication System), mobile ad hoc networks (MANET), mesh networks, and other networks having cognitive radio features, e.g. transmission medium sensing features and adaptive capability to coexist with radio access networks based on different specifications and/or standards. Some embodiments may be applicable to networks having features under development by other IEEE task groups. Therefore, the following description may be generalized to other systems as well.

The different wireless networks may operate at least partly on different channels, e.g. on different frequency channels. IEEE 802.11n specification specifies a data transmission mode that includes 20 megahertz (MHz) wide primary and secondary channels. The primary channel is used in all data transmissions with clients supporting only the 20 MHz mode and with clients supporting higher bandwidths. A further definition in 802.11n is that the primary and secondary channels are adjacent. The 802.11n specification also defines a mode in which a STA may, in addition to the primary channel, occupy one secondary channel which results in a maximum bandwidth of 40 MHz. IEEE 802.11ac specification extends such an operation model to provide for wider bandwidths by increasing the number of secondary channels from 1 up to 7, thus resulting in bandwidths of 20 MHz, 40 MHz, 80 MHz, and 160 MHz. A 40 MHz transmission band may be formed by two contiguous 20 MHz bands, and an 80 MHz transmission band may be formed by two contiguous 40 MHz bands. However, a 160 MHz band may be formed by two contiguous or non-contiguous 80 MHz bands. Different BSSs may employ different primary channels.

As mentioned above, the transmission band of a BSS contains the primary channel and zero or more secondary channels. The secondary channels may be used to increase data transfer capacity of a transmission opportunity (TXOP). The secondary channels may be called a secondary channel, a tertiary channel, a quaternary channel, etc. However, let us for the sake of simplicity use the secondary channel as the common term to refer also to the tertiary or quaternary channel, etc. The primary channel may be used for channel contention, and a TXOP may be gained after successful channel contention on the primary channel. Some IEEE 802.11 networks are based on carrier sense multiple access with collision avoidance (CSMA/CA) for channel access. Some networks may employ enhanced distributed channel access (EDCA) which provides quality-of-service (QoS) enhancements to medium access control (MAC) layer. The QoS enhancements may be realized by providing a plurality of access categories (AC) for prioritizing frame transmissions. The access categories may comprise the following priority levels in the order of increasing priority: background (AC_BK), best effort (AC_BE), video streaming (AC_VI), and voice (AC_VO). A higher priority frame transmission may use a shorter contention window and a shorter arbitration inter-frame spacing (AIFS) that result in higher probability of gaining the TXOP. Furthermore, some networks may employ restricted access windows (RAW) where a reduced set of wireless devices of the wireless network may carry out channel contention. An access node or a master node may define the RAW and a group of wireless devices that are allowed to attempt the channel access within the RAW. Grouping allows partitioning of the wireless devices into groups and restricting channel access only to wireless devices belonging to a specified group at any given time period. The time period may be enabled by allocating slot duration and a number of slots in RAW access. The grouping may help to reduce contention by restricting access to the medium only to a subset of the wireless devices. The grouping may also reduce the signalling overhead.

In a conventional 802.11 network, a wireless device initiating a TXOP may transmit a frame that triggers a network allocation vector (NAV). The frame may be a control frame such as a request-to-send (RTS) frame or a data frame. The frame may comprise a Duration field defining the duration of the NAV. Any other wireless device detecting the frame and extracting the Duration field suspends access to the same channel for the duration of the NAV. This mechanism may reduce simultaneous transmissions in the proximity that may be renamed as collisions. In some collisions the receiver cannot receive transmissions resulting to wasted transmission resources. The 802.11 networks may employ another collision avoidance mechanism called clear-channel assessment (CCA). A wireless device trying to access the channel scans for the channel before the access. If the channel is sensed to contain radio energy that exceeds a CCA threshold, the wireless device refrains from accessing the channel. If the channel is sensed to be free and no NAV is currently valid, the wireless device may access the channel. A conventional value for the CCA threshold may be −82 decibel-milliwatts (dBm) or −62 dBm depending on a channel access scheme, for example.

The wireless devices 110, 112, 114 may employ a randomized back-off time defining a minimum time interval they refrain from frame transmissions after detecting that the channel is busy. During the channel sensing, the back-off time may be decremented while the channel is sensed to be idle or available for the channel access. When the back-off time reduces to zero and the channel is still sensed to be idle, the wireless device may carry out the frame transmission. The back-off time value may be maintained for the duration the channel is sensed to be busy and, in some systems, for a determined guard time interval (e.g. the AIFS) after the detection that the channel has become idle.

Applications for short-range wireless devices are evolving to include awareness applications providing the device with an awareness about the local network environment. A non-limiting example of the neighbor awareness network architecture is the Nokia AwareNet framework, a network of wireless mobile devices self-organizing to support various applications, ranging from social networking to service discovery. Awareness information may be shared by a short-range wireless device sending an anonymous flooding message that may include a query, over an ad hoc network. A neighboring short-range wireless device may reply to the flooding message over the ad hoc network with a response, such as a pointer to a discovered location-based service.

Awareness information may include any information and/or context about a local network environment as well as the users and communication devices within the local network environment. Wireless devices may continuously collect and exchange information with other devices in a local network environment.

Awareness applications running on short-range wireless devices may create a network for sharing awareness information, locate and organize awareness information, form communities for sharing awareness information, manage power consumption for devices engaged in sharing awareness information, develop applications to take advantage of the awareness information, and maintain the privacy and anonymity of users sharing awareness information.

Awareness applications running on short-range wireless devices may employ a physical layer and a MAC layer based on the IEEE 802.11 specifications. The awareness application may build upon a scheme in which every device is responsible for participating in beaconing and all the other basic operations that keep the ad hoc network in operation. An ad hoc network may be designed to have one network identifier (NWID) that all of the devices in the network share. The NWID may be announced in the beacons transmitted by the devices. In the overall design, those devices that operate under same NWID are driven to use a common and shared schedule to allow for awareness information gathering among all the devices within range. The determination of which schedule is used by a device may be made by the network instance timer value, and this timer value is communicated in beacons in the timing synchronization function (TSF) value parameter. The devices may be required to operate by assuming the oldest TSF value (i.e. largest TSF value) contained in the received beacons that represent the network with the NWID in which the devices are operating. Alternatively the devices may be required to select the schedule which to follow based on some other criteria than the TSF value. Beacons may, as an example, contain some other information than the TSF that is used by the devices to determine which schedule to use.

When the radio and MAC of a wireless device transmits a Beacon, the Beacon MAC-header contains device's own current TSF value. The device may automatically transmit a reply message when it receives a Beacon from another network, the reply message being referred herein as a beacon response message. The beacon response message contains the current TSF value of the replying network. Alternatively the beacon response message may contain other information that is used to determine which schedule to use.

Wireless devices form a network where all devices in proximity may communicate with each other. When two or more groups of devices forming two or more instances of the network come close to each other, the two or more instances may merge to become one network instance. Devices may make a merging or join decision to change the instance autonomously based on the TSF information collected from Beacons received during scan periods or based on the TSF information collected from received beacon response messages. A merging decision may be performed when a device receives a Beacon or beacon response message with an older (greater) TSF value from another wireless device. Alternatively a merging decision may be done based on some other information available in a Beacon or beacon response message from another wireless device. After the merging decision has been performed by a device, the device moves into the new network instance.

The awareness functionality in a short-range wireless device may be divided between four layers in the awareness architecture. The Awareness Layer and the Community Layer provide services for applications, i.e. provide the awareness application program interface (API). The approximate functional split between the different layers is as follows.

According to an embodiment, Awareness Layer (AwL) has the highest level of control of the awareness architecture. Example services the AwL offers to the applications comprise Publish and Subscribe. The Awareness Layer receives publish and subscribe requests from applications and maps these into queries and query responses that, in turn, are mapped as awareness messages, the Network

Layer protocol data unit (PDU), that traverse from device to device. It also maps the awareness messages received by the device, to the application. The network layer does not appear as a data pipe for applications. A single awareness message is self-contained and short, the AwL compresses the messages in order for them to consume as little resources as possible.

The Awareness Layer may comprise an internal storage of awareness data items. Publishing an item normally means storing it in this internal storage (passive publish). Such an item is visible to other devices in the local vicinity and may be found using the Subscribe service. It is also possible to use active publishing that causes the Awareness Layer to issue a publish message that propagates from device to device. It is the responsibility of the AwL to decide whether a received message leads to the notification of an application (filtering). Items may be marked to be visible to only certain communities, so that they are visible only to searches made by members of such a community.

A Subscribe request causes the Awareness Layer to issue either a single or repetitive query message(s) that eventually propagate to other devices in the local vicinity (by using the functionality of lower awareness layers). When such a query message reaches the AwL of a device that happens to possess a matching information item, it responds with a reply message. The lower layers of awareness architecture take care of the routing of such a message back to the AwL of the querying device, which notifies the application of the other device that issued the Subscribe request.

The concept of communities has been integrally built into awareness architecture. Awareness communication may be visible to all the devices, or just to those that belong to a certain community. Regardless of this visibility, all wireless devices take part in the routing of messages. The role of the Community Layer (CoL) is to implement the community visibility rules. Only those messages that a certain device has visibility to (i.e. a device belongs to the same community as the message) are passed to the AwL. As an additional level of community privacy, messages are encrypted by the Community Layer. To allow such message filtering and encryption/decryption, the CoL stores the community credentials for those communities to which the user of the device belongs. The default awareness community (all local users) does not use any credentials and therefore its messages simply pass through the Community Layer.

According to an example embodiment, Awareness architecture comprises three different kinds of communities: the default awareness community, peer communities and personal communities. Communities may also be categorized with their privacy. Messages of public communities are transmitted as plain text whereas messages of private communities are transmitted encrypted. The default awareness community is the default community for all wireless devices. Awareness community messages are not encrypted and every node may send and receive awareness community messages (public community). In a peer community all members are equal and every member may receive all the community specific messages. A peer community may be public, or it may be private meaning that community messages are encrypted using a temporary key derived from the community specific shared key. The encryption function may be based on Advanced Encryption Standard, EAX mode (AES/EAX) with 128 bit keys. A personal community has a community owner that manages the community. A non-owner community member may communicate with the owner but not with other members of the community. A personal community is private, meaning that community messages from the owner to other members may be encrypted.

The Network Layer (NL) takes care of the local dissemination of the awareness messages. This is accomplished by way of a smart-flooding algorithm that attempts to adapt to the surrounding device density. At high densities, very few devices participate in the transmission of a given message. At low densities, all the devices may retransmit each message (normal flooding). The awareness network has a flat hierarchy; none of the devices may assume any special roles. Thus, at high densities, all the devices will transmit approximately the same amount of traffic (no clustering). The Network layer may also take care of the routing of the replies back to the device that issued the search. To this end, it collects routing information from the messages that flow through it. It also keeps track of all the neighbors and their approximate distance. Normally, reply routing uses unicast transmissions, whereas flooding messages are always broadcasted. All the messages received by the Network Layer are passed to Community Layer in order to check whether the message should be processed in the AwL.

Link Layer performs the adaptation between the underlying radio technology (e.g. IEEE 802.11 WLAN physical layer) and the Network Layer. It maps the specific information of the radio technology, such as radio identifiers and received signal strengths, into technology neutral information used by the Network Layer (NL). Multiple Link Layer instances may be used by the NL, e.g. for simultaneous usage of different radio technologies.

The Link Layer may be divided into two sub layers: logical link control (LLC) and medium access control (MAC). LLC provides radio technology agnostic service for the Network Layer. It hides differences between radio technology specific MACs. LLC provides a single service access point for the Network layer. LLC knows how to map the generic provided service to the service provided by the technology specific MACs. The LLC internal data structures include the Neighbor Table that contains information of all the neighboring devices that have been heard in the recent past.

The Link Layer tries to transmit data via the given medium using the TransmitData functionality. Transmission may succeed or it may fail. Internally the Link Layer may try transmissions several times if a medium is temporarily busy. The Link Layer passes all the messages it receives to the Network Layer. This also includes unicast messages that are intended for other nodes.

The logical link control (LLC) is aware of radio technology specific MACs. In case of the IEEE 802.11 WLAN MAC example, the LLC does the following WLAN MAC specific actions: Control (Reset, Configure) WLAN MAC; decide when to merge WLAN networks; construct a message package to be sent to WLAN MAC from outgoing messages; select which messages are to be sent and which are ignored immediately, e.g. if there are too many messages to be sent; extract incoming data messages contained in reception reports; update the Neighbor Table when reception reports and scan reports are received.

Merging of WLAN networks may be the responsibility of the logical link control (LLC). The LLC may determine when to merge two WLAN network instances or beacon groups as a single larger network instance or a beacon group. LLC may calculate an estimate of its own WLAN network size. Estimation may be based on information provided by the Network Layer, information found in the LLC Neighbor Table and network size category shared by other nodes. A network size category is calculated from an estimated network size.

The IEEE 802.11 WLAN MAC awareness mode enables a wireless device to use its power efficiently. In the awareness mode, the WLAN radio is asleep most of the time, thus reducing power consumption. Messages are transmitted and received in a batch mode, i.e. LLC passes all the messages that the MAC is to transmit during a single awake period, in a single package. The MAC passes all the messages received during a single awake period in a single reception report. The LLC collects messages to be transmitted in a single package. When the MAC is awake, the LLC passes the package to the MAC and it tries to transmit the messages. When the MAC is about to go asleep, it sends a transmission report to the LLC containing information about messages it has succeeded to transmit and about messages it has failed to transmit. In addition MAC passes a reception report to LLC. The report contains messages received during the awake period.

According to an embodiment, the merging or joining process is a purely local process that occurs entirely internally to the wireless device. There is no indication to the outside world that a device has joined a particular ad hoc network. Joining an ad hoc network may require that all of the mobile device's MAC and physical parameters be synchronized with the desired ad hoc network. To do this, the device may update its timer with the TSF value of the timer from the ad hoc network description, modified by adding the time elapsed since the description was acquired. This will synchronize the device's timer to the ad hoc network. The BSSID of the ad hoc network may be adopted, as well as the parameters in the capability information field. Once this process is complete, the wireless device has joined the ad hoc network and is ready to begin communicating with the wireless devices in the ad hoc network.

The IEEE 802.11 WLAN MAC awareness mode provides the following functionalities: reset MAC; configure MAC; join a WLAN network or create a new network; join an existing WLAN network (BSSID is known); set a template for beacon frames so that LLC parameters can be passed in WLAN beacon frames; try to transmit a set of messages; receive a set of incoming messages; receive a set of WLAN scan messages; message propagation.

According to an embodiment, the propagation of an awareness search message is conducted in the awareness architecture layers of different devices. An application initiates a subscription in the device by using the Subscribe service offered by the Awareness Layer. The Awareness Layer realizes the subscription by sending a query message to other devices. In all the devices the message goes at least up to the Community Layer. However, only in those devices that belong to the community to which the message was intended, does the message proceed to the AwL. There is no need to have an application present in the replying device. It is sufficient to only have the awareness platform active.

In accordance with an example embodiment, the present invention may be used in the logical architecture of the Neighbor Awareness Networking (NAN) program being standardized by the Wi-Fi Alliance (WFA). The NAN protocol stack is expected to comprise of two components: 1) NAN Discovery Engine, 2) MAC with NAN support. MAC with NAN support is a variant of Wi-Fi MAC and provides means for NAN devices to synchronize in time and frequency to provide common availability periods for service discovery frames from/to the NAN Discovery Engine.

The NAN Discovery Engine may provide Publish and Subscribe services to the applications for service discovery purposes. Publishing is the ability to make application-selected information about e.g. capabilities and services available for other NAN devices that seek information with Subscribing, using protocols and mechanisms certified by the Neighbor Awareness Networking program. NAN devices that use Publishing may provide published information in an unsolicited or solicited manner. Subscribing is the ability to discover information that has been made available in other NAN devices with Publishing, using protocols and mechanisms certified by the Neighbor Awareness Networking program. NAN devices that use Subscribing may passively listen for or actively seek published information.

Publish and Subscribe services are expected to exploit a discovery protocol that the NAN Discovery Engine implements and which is designed for NAN. The protocol is expected to have two different protocol messages: 1) Discovery query message, and 2) Discovery response message. The Subscribe service is expected to use the Discovery query message to conduct active discovery. The Subscribe service may be configured to operate in passive mode only. In this mode, no Discovery query messages are transmitted, but one listens for Discovery response messages to find the information sought. The Publishing service is expected to use the Discovery response message to announce availability of application-selected information to discovering devices.

A device in which the Subscribe service has been activated in active mode, transmits Discovery query messages to trigger Publishing devices to transmit Discovery response messages. In parallel, the Subscribing device monitors received Discovery response messages to determine the availability of services and information being sought. Monitoring is envisioned to be a continuous process that applies to all Discovery response messages received while the Subscribe service is active. With this approach, a Subscribing device may gather valuable information from Discovery response messages that are independent from its own Discovery query message transmissions.

The MAC with the NAN support is responsible for acquiring and maintaining time and frequency synchronization among devices that are close by, so that the devices are available for discovery protocol message exchange in same channel at same time. Synchronization happens through dedicated synchronization frames that are transmitted by so called master devices (on default) at the beginning of the availability periods. Sync frames are transmitted periodically on certain channel(s). Periodicity and channel usage is determined by sync frame parameters. Each device may be capable of acting as a master device and each device is expected to determine for each availability period whether it is a master device or not. This determination is done through a master election algorithm. The synchronization frames determine the schedule (time and frequency) of both the synchronization frame transmissions and the availability periods or discovery windows.

A NAN network is comprised of a set of NAN devices that operate under a common network identifier (NAN ID) and that share common sync frame and discovery window parameters. A NAN network comprises of one or more NAN clusters. Each NAN cluster may be a contention group or beacon group and may be considered a local representation of a NAN network. A NAN cluster is comprised of a set of NAN devices that operate in a NAN network with one NAN ID and which are synchronized with respect to both the sync frame transmissions and the discovery windows. In order for NAN devices to form a NAN cluster, at least some of them need to be within range of each other. The NAN ID is carried at least in synchronization frames that may be of a beacon frame format. Each beacon contains a NAN ID field that is used in a NAN device receiving a beacon, to determine, as an example, whether the beacon is from a NAN network in which the NAN device is operating and from what type of NAN network the beacon was transmitted. In one embodiment of the invention, the NAN ID is a numerical value that is indicated with a 6-octet field in beacons or in synchronization frames used in the NAN networks, to provide basic synchronization within NAN clusters. In one embodiment of the invention, there is no NAN cluster identifier that would be carried in beacon frames, but NAN cells are differentiated with different schedules especially from perspective of sync frame (beacon) schedule.

Let us now consider some basic principles of NAN operations. Upon activating the NAN functions in a device, the device first looks for a NAN network by means of passive discovery. The NAN functions are activated by an application in the device requesting either the Subscribe or the Publish service to be activated, when there is no service active in the NAN Discovery Engine. On default, there is at least one NAN ID that is determined in a NAN specification and the NAN device looks for such a network and its clusters. With respect to joining a NAN network/NAN cluster, if the device finds at least one NAN cluster that the device may join, the device selects a cluster and joins it. If the device finds no NAN cluster that the device may join, the device establishes a NAN cluster of its own. An application may have also requested the Publish service to be activated in a passive mode. In such case the device doesn't ever establish a NAN cluster, but it only operates in NAN clusters that have been established by others.

A NAN device may join a NAN cluster when the following criterion is met: the device receives at least one sync frame from the cluster with signal level exceeding a pre-determined threshold RSSI_C (e.g. −50 dBm); upon joining a NAN cluster a NAN device synchronizes itself both to the sync frame transmission and discovery window schedule of the cluster; the device is responsible for running the master election algorithm to determine whether it is a master device that is responsible for transmitting a sync frame. Once in a NAN cluster, a NAN device may continue operating in it, as long as one of the following criteria is met: the device receives at least one sync frame from the cluster with signal level exceeding a pre-determined threshold RSSI_C (e.g. −50 dBm); the device operates as a master device transmitting sync frames. When operating in a NAN cluster, a NAN device is responsible for maintaining both the base clock of the cluster by transmitting sync frames as needed and the discovery window schedule of the cluster. Additionally, a NAN device is responsible for conducting passive discovery once in a while to figure out whether there are other NAN clusters within range that that the device should consider joining. When a NAN device detects a sync frame of a NAN cluster different from the one in which the device operates, but both the clusters belong to the NAN network the device operates in, and the sync frame is received with signal level exceeding a pre-determined threshold RSSI_C (e.g. −50 dBm), the device proceeds as follows: if the sync frame from the foreign cluster contains parameter values that indicate preference of the foreign cluster over one's own cluster, the device moves its operations to the foreign cluster; otherwise the device continues its operations in the current cluster.

A NAN network is comprised of a set of NAN devices that operate under a common network identifier (NAN ID) and that share common sync frame and discovery window parameters. A NAN network is comprised of one or more NAN clusters. A NAN cluster may be defined as a set of NAN devices that operate in a NAN network with one NAN ID and that are synchronized with respect to both the sync frame transmissions and the discovery windows form a NAN cluster. In order for NAN devices to form a NAN cluster, at least some of them need to be within range of each other. Synchronization within a NAN cluster means that the devices share the burden of sync frame transmission and are available simultaneously for NAN discovery during discovery windows.

Sync frames form the basis of time and frequency synchronization in the NAN network. All the NAN devices are responsible for participating in sync frame transmission, as per master role selection rules. Sync frames are transmitted as per sync frame parameters that determine how often and in which channel(s) the frames are transmitted. Sync frames provide a base clock for NAN devices and the base clock is used as the reference when specifying the discovery window schedule. The base clock builds upon the time synchronization function (TSF) that is used in WLAN, and each sync frame is expected to contain a TSF timestamp value indicator. A sync frame may be realized as a Beacon frame.

A discovery window is a time period during which NAN devices are available for NAN discovery frame exchange. Discovery windows happen as per discovery window parameters that determine how often and in which channel(s) the windows happen. A discovery window schedule builds upon the information available in sync frames.

Upon activating the NAN in a device, the device first looks for a NAN network by means of passive discovery. On default, there is one default NAN ID that is determined in a NAN specification and the NAN device looks for such a network and its clusters. If the device finds at least one NAN cluster that the device may join, the device selects a cluster and joins it. If the device finds no NAN cluster that the device may join, the device establishes a NAN cluster of its own. If the NAN Discovery Engine has been requested to activate the Subscribe service in a passive mode, the device may also decide not to establish a NAN cluster of its own, but it only operates in NAN clusters it discovers. When a NAN device operates in a NAN cluster, it periodically conducts passive discovery to find out whether other NAN clusters of the NAN network in which the device operates, are available.

A NAN device may join a NAN cluster when the following criterion is met: the device receives at least one sync frame from the cluster with signal level exceeding a pre-determined threshold RSSI_C (e.g. −50 dBm). Upon joining a NAN cluster, a NAN device synchronizes itself both to the sync frame transmission and discovery window schedule of the cluster. Additionally, the device is responsible for running the master election algorithm to determine whether it is a master device that is responsible for transmitting a sync frame.

A NAN device may continue operating in a NAN cluster as long as one of the following criteria is met: the device receives at least one sync frame from the cluster with signal level exceeding a pre-determined threshold RSSI_C (e.g. −50 dBm); the device operates as a master device transmitting sync frames. When operating in a NAN cluster, a NAN device is responsible for maintaining both the base clock of the cluster by transmitting sync frames as needed, and the discovery window schedule of the cluster.

In accordance with an example embodiment of the invention, a node, device, or STA may operate in one of two roles. As a Master STA, it competes with other Master STAs to transmit a Beacon, both for NAN synchronization and NAN discovery purposes. As a Non-Master STA, it may need to compete to transmit a Beacon, but only for NAN synchronization purposes. The Master Sync STA role may be determined by the Master Election Algorithm for Neighbor Awareness Networking. Every node, device, or STA of an ad hoc network may need to be able to operate in both roles and the Master Election Algorithm may need to be run by every node, device, or STA once in a while or periodically.

A NAN device that operates in a NAN cluster may need to be responsible for determining for each discovery window, as per the master election algorithm, whether it is a master device.

When a NAN device detects a sync frame of a NAN cluster different from the one in which the device operates, but both the clusters belong to the NAN network the device operates in, and the sync frame is received with signal level exceeding a pre-determined threshold RSSI_C (e.g. −50 dBm), the device proceeds as follows: if the timestamp (e.g. TSF value) in the sync frame from the foreign cluster is larger than the time in one's own cluster, the device moves its operations to the foreign cluster; alternatively some other information in the sync frame from the foreign cluster is analyzed to determine whether the device moves its operations to the foreign cluster; otherwise the device continues its operations in the current cluster.

When a NAN device operates in a cluster, it shall do as follows when moving its operations to a new cluster upon detecting the existence of the new cluster through passive discovery. If the device is a master device in the current/old cluster, the rules are as follows: the device transmits as a master device in the current/old cluster at least one sync frame that contains information about the new cluster (his includes information at least about TSF value and discovery window schedule of the new cluster); once the device has transmitted at least one sync frame in the current/old cluster with information about the new cluster, it shall start operating in the new cluster and ceases all the operations in the old cluster. If the device is a non-master device in the current/old cluster, the rules are as follows: the device shall start operating in the new cluster and ceases all the operations in the old cluster.

In the service discovery of the NAN networks and in some other networks, the frames used in the service discovery are transmitted as broadcast messages, and a device receiving the broadcast frame may be configured to forward received broadcast frames to a host of the service. The forwarding consumes power in the device and, in many occasions, the device forwards traffic of other devices. The forwarding may comprise a radio modem implementing the Link layer extracting the received frame and forwarding payload of the frame to a system processor implementing the upper layer such as the network layer and the awareness layer. The awareness layer may determine whether or not to forward the payload onwards in the network.

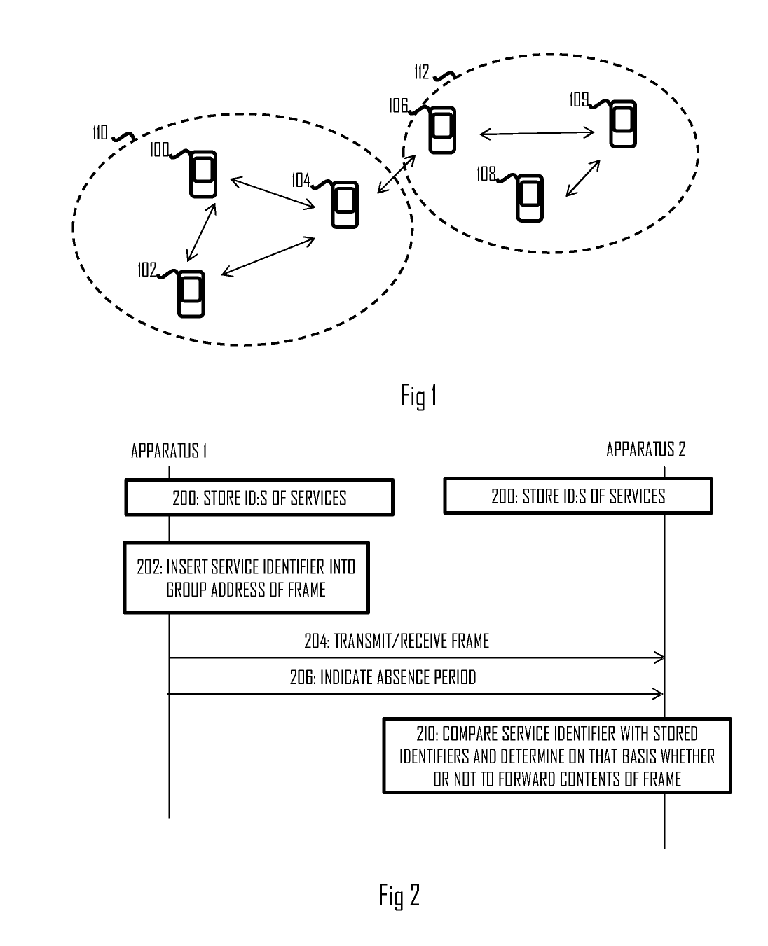

FIG. 2 illustrates a signalling diagram of a procedure for indicating a service identifier. The signalling may be performed between a first apparatus and a second apparatus. Referring to FIG. 2, both the first apparatus and the second apparatus may store at least one service identifier of at least one service (block 200). In block 202, the first apparatus inserts a service identifier of a service into a group address of a frame to be transmitted. In block 204, the first apparatus causes transmission of said frame, and the second apparatus receives the frame comprising the service identifier in the group address of the frame. In block 210, the second apparatus determines, on the basis of the service identifier comprised in the received frame and the stored at least one service identifier whether or not to output contents of the frame to a higher protocol layer.

Providing the service identifier in the group address of the frame provides several advantages. It reduces protocol overhead because the service identifier needs not to be signalled separately. Furthermore, it enables processing and identifying the service identifier on a lower protocol layer than in a conventional case where the service identifier is comprised in a data part of the frame or in a header processed by a protocol layer higher than a physical layer or a MAC layer. This is useful in the NAN and other wireless networks where the devices a configured to forward messages of other devices, because it enables filtering of the forwarded messages on a lower protocol layer. Accordingly, the second apparatus may determine in an earlier stage whether or not to forward the message.

The service identifier may thus be provided in an address field of the frame. In an embodiment, the group address comprises a medium access control address. The service identifier may be a part of a medium access control address of the frame. Accordingly, the service identifier may be identified and processed by a MAC layer of the apparatus.

The frame may comprise a service discovery frame comprising at least one of the following messages: a subscribe request, a subscribe query, a subscriber response. The frame may be a data frame carrying data of the service associated with the service identifier. In an embodiment employing the NAN network or another wireless network, the services may be advertised with the data frames or only with the data frames. In such an embodiment, the need for signaling frames, dedicated service discovery frames, or dedicated service advertisement frames may even be avoided.

The service associated with the service identifier may be a local service provided in the NAN or, in general, in the local area network. The service may be limited to the wireless network of the local area network and, thus, only devices of the local area network may use the service. The service may be a service provided by the application layer. The service may employ a user interface of the apparatus. The service may be a file distribution service, a data distribution service, or data sharing service. The service may be a device resource service such as provision of a printing service or another service by a peripheral device. The service may be a memory storage service in which devices may upload data to a cloud storage. The service may be a gaming service, a dating service, a messaging service, a social networking service, or a service for getting into contact with new people and for making friends.

With respect to the stored list of services (block 200), the list of service identifiers may be associated with the services to which the respective apparatus belongs, e.g. as a publisher of the service or as a subscriber of the service. In such an embodiment, the second apparatus may use the list to filter the messages forwarded to the higher layer on the basis of whether or not the second apparatus uses the service. The second apparatus may forward messages of the services the second apparatus uses and not forward messages of the services the second apparatus does not use. In another embodiment, the stored list of services and associated service identifiers comprises services for which the apparatus has determined to transmit messages. This may comply with the above-described scheme where the apparatus estimates, on the basis of the network density for each service, whether or not the apparatus is needed in the message forwarding. The apparatus may then store in block 200 service identifiers of the services for which the apparatus needs to forward the messages. In another embodiment, the apparatus may then store in block 200 service identifiers of the services for which the apparatus needs not to forward the messages. In general, the list of service identifiers may be understood to provide information enabling the apparatus to determine on the basis of the service identifier of the received frame, whether or not forward the contents of the message associated with the service identifier needs to be forwarded to the higher layer.

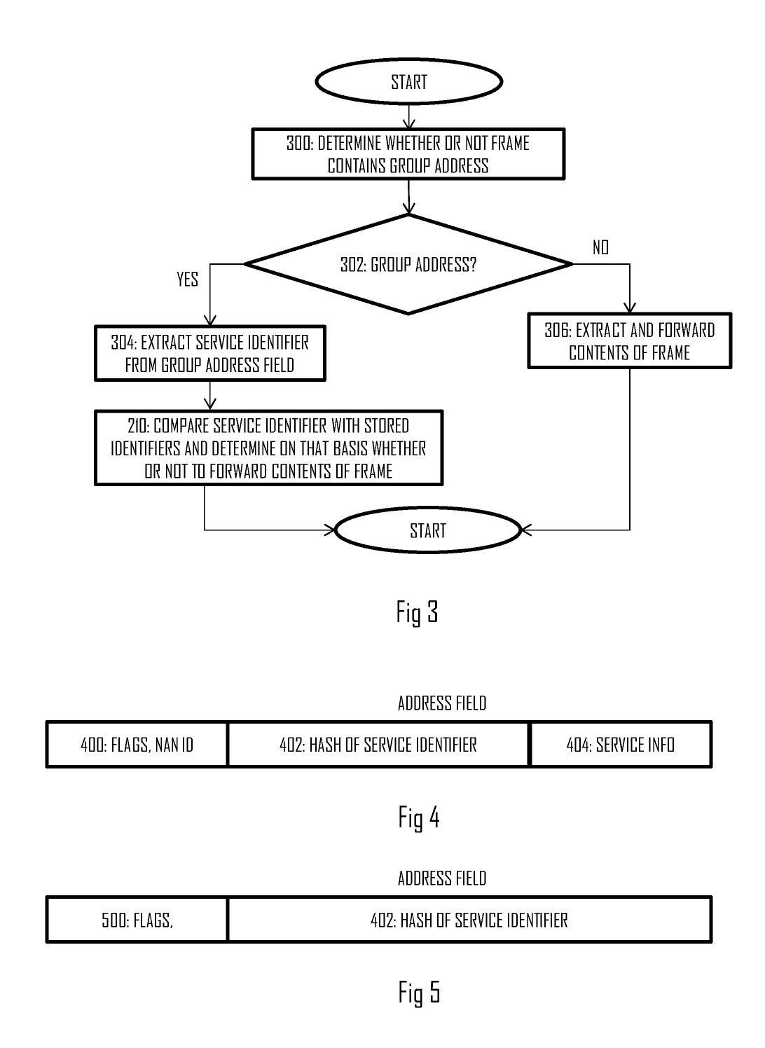

As described above, the group address such as a multicast address or a broadcast address of the frame may be arranged to comprise the service identifier. A multicast address may be defined as an address specifying a limited number of recipient devices. As a consequence, a frame transmitted to a multicast address may be received by a limited number of recipients that are associated with the multicast address. A broadcast address may be defined as an address specifying an unlimited number of recipient devices. As a consequence, a frame transmitted to a broadcast address may be received by any device capable of interpreting the contents of the frame. A unicast address may be defined as an address specifying a single recipient device. Unicast addresses may be used in a conventional manner, e.g. they may comprise a device address of a recipient of the frame but not a service identifier. In an embodiment, the frame may comprise an indicator in the form of a flag, for example, wherein the indicator indicates whether the frame is addressed to a unicast address or to a group address such as a multicast address. FIG. 3 illustrates an embodiment of a procedure that may be carried out in the second apparatus of FIG. 2 upon receiving the frame. Referring to FIG. 3, the second apparatus may determine in block 300 whether or not the frame comprises a group address, e.g. in a MAC header. Block 300 may comprise checking the indicator from the MAC header. The indicator may be included in a recipient address field of the header, for example. Upon determining that the frame contains a unicast address in block 302, the process may proceed to block 306 in which the frame is processed in a conventional manner. Upon determining in block 302 that the frame comprises a group address, the process may proceed from block 302 to block 304 in which the group address is processed by extracting a service identifier from the group address. Upon extracting the service identifier, the second apparatus may determine further processing of the contents of the frame in block 210, e.g. in the above-described manner.

A publisher or a host of the service associated with the service identifier may be configured to generate the group address from at least the service identifier of the service. The service identifier may be subjected to a hash function in the publisher, wherein the hash function maps the service identifier into a specific bit combination representing the service identifier in the group address.

In an embodiment, at least a part of the service identifier may be comprised in a physical layer convergence protocol (PLCP) header of the frame or, in general, frames transmitted in connection with the service. The apparatus receiving the frame may then process the frame and the PLCP header with physical layer processing and determine, on the physical layer, whether or not to forward the header to the higher layer. In the embodiment where the part of the service identifier is comprised in the PLCP header, a determined number of bits of the service identifier comprised in the group address, e.g. a determined number of first bits or last bits, may be allocated to a determined field in the PLCP header. The second apparatus receiving the frame may store a first set of service identifiers formed from these shortened service identifiers and compare, on the physical layer, the service identifier comprised in the PLCP header with the first set of service identifiers. The second apparatus may further store a second set of service identifiers that represent the service identifiers applied to the group address of MAC headers. Upon determining, on the basis of the comparison, that the contents of the frame are forwarded to the higher layer, the second apparatus may process the service identifier comprised in the group address of the MAC header on the MAC layer. The processing may comprise comparison between the service identifier extracted from the group address of the MAC header and the second list of service identifiers. The comparison may serve as the basis for determining whether or not to forward the contents of the frame to the higher layer. Such a processing enables fast filtering of the messages on the physical layer and on the MAC layer.

Let us now consider some embodiments of the group address with reference to FIGS. 4, 5, and 6 and Tables below. Referring to FIG. 4, the group address of the frame may comprise one or more flags 400. The one or more flags 400 may be provided at the start of the group address, for example. The one or more flags 400 may comprise the above-described flag for indicating whether the address is the group address or the unicast address.

The one or more flags may comprise a flag that indicates whether or not the service identifier contained in the address field is a universally managed service identifier or a locally managed service identifier. In connection with WLAN, there exist services that are assigned a globally unique service called organizationally unique identifier (OUI). A locally managed service identifier may be generated locally for a service, and there is a possibility that another, different service provided in another wireless network may be assigned the same service identifier. The second apparatus of FIG. 2 receiving the frame comprising such a flag indicating whether the service identifier is managed locally or globally may interpret the contents of the address field differently, depending on the value of the flag, as illustrated in FIGS. 4 to 6 and Tables below.

The address field may further comprise an identifier of the wireless network in which the service is provided, e.g. the NAN network. The address field may then comprise the service identifier 402. The address field may further comprise an application-specific part that indicates characteristics of the service. The application-specific part may comprise a service information field 404 that may be used by the service to provide information that is specific for the service. The field may specify a service-specific frame type or signalling information specific for the service identified with the service identifier 402. For instance, a video streaming service may differentiate control, audio and video information to be transmitted in separate packets. The separation enables the receivers to receive only the type of data that they are interested. The service information field 404 may thus comprise information that indicates which type of data the frame carried, e.g. control, audio, or video data, which enables the second apparatus receiving the frame to filter the frame on the basis of the type of data. For example, if the second apparatus chooses to receive only audio data, the stored list of service identifiers may indicate that only a frame comprising the service identifier of the correct service and a value of the service information field that indicates the audio data will be forwarded to the higher layer. A frame comprising the service identifier of the correct service and a value of the service information field that indicates data other than the audio data may be discarded without forwarding it to the higher layer.

In another embodiment, the service information field 404 may be used to identify devices within the service associated with the service identifier carried in the frame. For example, if the same walkie-talkie service is used by multiple devices, each device may be assigned with a unique identifier that is included in the service information field and used as a receiver address for the frame. Alternatively or additionally, the devices may be divided into groups, a group comprising multiple devices, and each group may be assigned a unique address defined in the service information field 404. Table 1 below illustrates the contents of the address field of FIG. 4 in more detail.

TABLE 1

| Octet 0 | | | | Octet 1 | Octet 2 | Octet 3 | Octet 4 | Octet 5 |
|---|---|---|---|---|---|---|---|---|
| 1 | 1 | 1 | 5 | Service Identifier | | | | Service |
| | | | | | | | | Info |

Referring to Table 1, each octet may comprise eight bits. One of the three one-bit fields of Octet 0 may comprise the flag indicating whether the address is the unicast address or the group address, e.g. the first bit. When the flag indicates the unicast address, the fields of FIG. 4 and Table 1 may not be present except for this flag. When the flag indicates the group address, the fields of FIG. 4 and Table 1 may be present. One of the three one-bit fields may comprise the flag indicating whether the service identifier is managed locally or globally, e.g. the second bit. One of the three one-bit fields may comprise a flag indicating whether the frame carrying the service identifier publishes information on the service or subscribes information on the service. The flag may be considered as a role part or a role field specifying a role of the apparatus transmitting the frame, e.g. the publisher or the subscriber. The publisher may be considered as a service provider. In an embodiment, the second apparatus may belong to a service but be configured to forward only some messages of the service. For example, the second apparatus may be configured to forward only those messages that publish information on the service or those messages that subscribe to the service. This bit may be used to filter the contents forwarded to the higher layer in combination with the service identifier. The five-bit field of Octet 0 may carry the identifier of the wireless network, e.g. the NAN radio network, or an identifier of the transmitting device, e.g. the identifier of the first apparatus in the process of FIG. 2. Four octets may be reserved for the service identifier 402, and one octet for the service information field 404.

In the embodiment of FIG. 5, the network identifier, the flag indicating the publish/subscribe feature, and the service information field 404 are omitted from the address field. Accordingly, the address field may comprise a flags field and a longer service identifier part or field with respect to the embodiment of FIG. 4. Table 2 below illustrates the address field of FIG. 5 in greater detail.

TABLE 2

| | | | | | |
|---|---|---|---|---|---|
| Octet 0 | Octet 1 | Octet 2 | Octet 3 | Octet 4 | Octet 5 |

| | | |
|---|---|---|
| 1 | 1 | Service Identifier |

In this embodiment, the service identifier may be hashed into a 46-bit identifier.

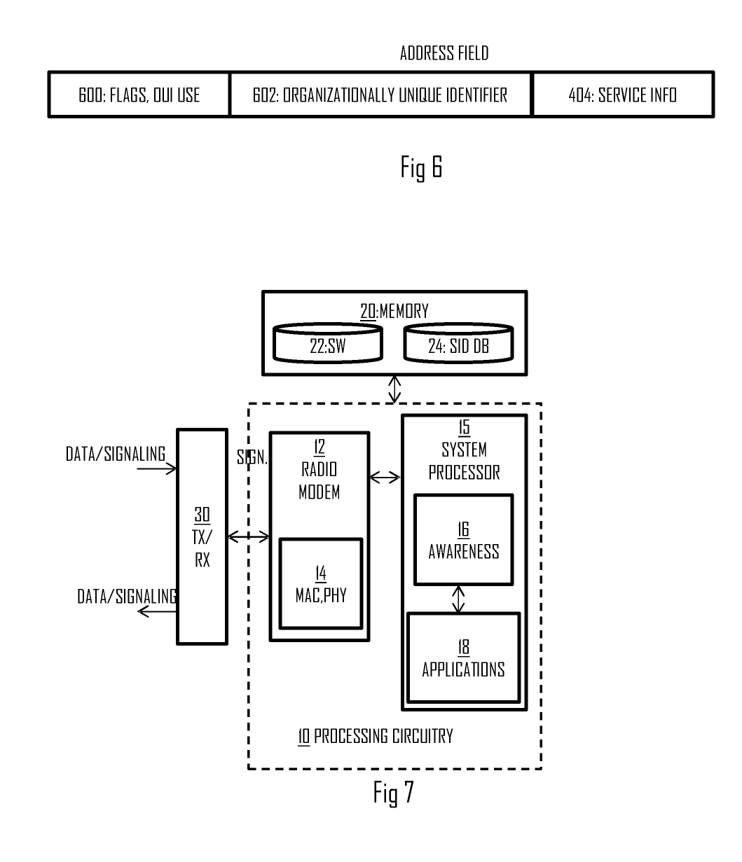

As described above, the OUIs may serve as globally unique service identifiers that may also be identified in the address field. FIG. 6 illustrates an embodiment where the address field comprises the OUI. Accordingly, the first apparatus transmitting the frame may generate the group address on the basis of the OUI associated with the service. When the group address is generated from the OUI, the flag indicating the global or local service identifier management may be set to indicate global management. The second apparatus reading the flag may then search for the OUI from the group address. Referring to FIG. 6, the address field carrying the group address may comprise a part 600 that comprises at least some of the flags described above. Additionally, the group address may comprise a part (part 600 or another part) that further defines the service associated with the OUI. A vendor or service provider may have reserved an OUI from a managing entity such as the IEEE and use the OUI in connection with a plurality of services provided in wireless networks. In such a case, the further definition of the service associated with the OUI may be used to explicitly define the service in the group address field.

The address field further comprises the OUI 602 and, in some embodiments, the service information field 404 indicating some service-specific parameters of the service associated with the OUI. Tables 3 and 4 below illustrate detailed embodiments of the address field of FIG. 6.

TABLE

| | | | | | |
|---|---|---|---|---|---|
| Octet 0 | Octet 1 | Octet 2 | Octet 3 | Octet 4 | Octet 5 |

| | | | | |
|---|---|---|---|---|
| 1 | 1 | 6 | OUI | Service Info |

In Table 3, one of the two one-bit fields of Octet 0 may comprise the flag indicating whether the address is the unicast address or the group address, e.g. the first bit. The other of the two one-bit fields may comprise the flag indicating whether the service identifier is managed locally or globally, e.g. the second bit. In the case the address field comprises the OUI, the flag may indicate the global management of the service identifier. The OUI may in this embodiment be a 24-bit identifier, and two octets may be reserved for the service-specific information.

TABLE 4

| | | | | | | |
|---|---|---|---|---|---|---|
| Octet 0 | Octet | 1 | Octet 2 | Octet 3 | Octet 4 | Octet 5 |

| | | | | |
|---|---|---|---|---|
| 1 | 1 | 6 | OUI (36 bits) | Service |
| | | | | Info |

The embodiment of Table 4 differs from the embodiment of Table 3 in the length of the OUI and the service information field. The OUI may have the length of 36 bits, while four bits are reserved for the service-specific information.

Instead of providing the above-described information in the specific fields in the group address of the frame, the information may be provided in a part of the frame that may be a separate field or subfield of the frame, or even a part of a field or sub-field. For example, the service identifier may form a part of the group address field of the frame.

FIG. 7 illustrates an embodiment of an apparatus comprising means for carrying out the above-mentioned functionalities of a wireless device implementing the functions of the above-described first apparatus and/or the second apparatus. The wireless device may comply with specifications of an IEEE 802.11 network and/or another wireless network. The wireless device may also be a cognitive radio apparatus capable of adapting its operation to a changing radio environment, e.g. to changes in the networking environment. The wireless device may be or may be comprised in a computer (PC), a laptop, a tablet computer, a cellular phone, a palm computer, or any other apparatus provided with radio communication capability. In another embodiment, the apparatus carrying out the above-described functionalities of the wireless device is comprised in such a wireless device, e.g. the apparatus may comprise a circuitry, e.g. a chip, a chipset, a processor, a micro controller, or a combination of such circuitries in the wireless device.

Referring to FIG. 7, the apparatus may comprise a processing circuitry 10. The processing circuitry may comprise at least two sub-circuitries: a radio modem 12 and a system processor 15. The radio modem 12 and the system processor 15 may be two different processors or processing circuitries. In some embodiments, the apparatus according to an embodiment of the invention is the radio modem 12 but, in other embodiments, the apparatus comprises the system processor 15 and optionally other components or articles illustrated in FIG. 7. The radio modem 12 may implement the physical layer processing and the MAC layer processing 14 described above. The radio modem 12 may process the group address field of a received frame, extract the service identifier from the group address field, and determine whether or not to forward the contents of the frame to the system processor 15. The system processor 15 may implement the higher layer processing such as the awareness layer 16 and computer program applications 18 that use the services associated with the service identifiers.

The circuitries 12 to 18 of the processing circuitry 10 may be carried out by the one or more physical circuitries or processors. In practice, the different circuitries may be realized by different computer program modules. Depending on the specifications and the design of the apparatus, the apparatus may comprise some of the circuitries 12 to 18 or all of them.

The apparatus may further comprise a memory 20 that stores computer programs (software) 22 configuring the apparatus to perform the above-described functionalities of the wireless device. The memory 20 may also store communication parameters and other information needed for the wireless communications. The memory 20 may store a service identifier database 24 storing service identifiers used in the message filtering carried out by the radio modem according of the above-described embodiments. The service identifier database 24 may store service identifier information enabling the radio modem to determine, for each service identified on the basis of the group address field of a received frame, whether or not to forward the message to the system processor 15. The system processor 15 may comprise a module determining the contents of the service identifier database, e.g. the module may select the services for which the forwarding shall be applied by the radio modem 12. In some embodiments, the module may determine types of messages of each selected service for which the forwarding shall be applied, e.g. forwarding is applied only to messages that publish information on the service.

The apparatus may further comprise radio interface components 30 providing the apparatus with radio communication capabilities within one or more wireless networks. The radio interface components 30 may comprise standard well-known components such as an amplifier, filter, frequency-converter, (de)modulator, and encoder/decoder circuitries and one or more antennas. The apparatus may in some embodiments further comprise a user interface enabling interaction with the user of the communication device. The user interface may comprise a display, a keypad or a keyboard, a loudspeaker, etc.

In an embodiment, the apparatus carrying out the embodiments of the invention in the wireless device comprises at least one processor 10 and at least one memory 20 including a computer program code 22, wherein the at least one memory and the computer program code are configured, with the at least one processor, to cause the apparatus to carry out the functionalities of the first apparatus and/or the second apparatus according to any one of the embodiments of FIGS. 2 to 6. According to an aspect, when the at least one processor 10 executes the computer program code, the computer program code causes the apparatus to carry out the functionalities of the first apparatus and/or the second apparatus according to any one of the embodiments of FIGS. 2 to 6. According to another embodiment, the apparatus carrying out the embodiments of the invention in the wireless device comprises the at least one processor 10 and at least one memory 20 including a computer program code 22, wherein the at least one processor 10 and the computer program code 22 perform the at least some of the functionalities of the first apparatus and/or the second apparatus according to any one of the embodiments of FIGS. 2 to 6. Accordingly, the at least one processor, the memory, and the computer program code form processing means for carrying out embodiments of the present invention in the wireless device. According to yet another embodiment, the apparatus carrying out the embodiments of the invention in the wireless device comprises a circuitry including at least one processor 10 and at least one memory 20 including computer program code 22. When activated, the circuitry causes the apparatus to perform the at least some of the functionalities of the first apparatus and/or the second apparatus according to any one of the embodiments of FIGS. 2 to 6.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 2 to 6 may also be carried out in the form of one or more computer processes defined by one or more computer program. A separate computer program may be provided in each apparatus that executes functions of the processes described in connection with the Figures. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1-10. (canceled)

11. A method comprising:
storing, by an apparatus, at least one service identifier of at least one service;
receiving, by the apparatus, a frame comprising a service identifier of a service in a group address of the frame;
determining, on the basis of the service identifier comprised in the received frame and the stored at least one service identifier whether or not to output contents of the frame to a higher protocol layer.

12. The method of claim 11, wherein the determining is carried out in a radio modem of the apparatus, and wherein the contents of the frame are output from the radio modem to a system processor upon determining to output the contents of the frame to the higher protocol layer.

13. The method of claim 11 or 12, further comprising upon determining not to output the contents of the frame to the higher layer: discarding the contents of the frame.

14. The method of claim 11, wherein the apparatus is functioning as a service subscriber or a service publisher in a neighbour awareness networking network, and wherein the at least one service for which the apparatus has stored a service identifier consists of services where the apparatus is the service subscriber or the service publisher.

15. The method of claim 11, wherein the frame is a data frame, and wherein the group address comprises a medium access control field.

16. The method of claim 15, wherein the service identifier is a part of a medium access control address of the frame.

17. The method of claim 11, wherein the group address comprises an application-specific part indicating characteristics of the service.

18. The method of claim 11, wherein the group address comprises a service identifier part for the service identifier.

19. The method of claim 11, wherein the service identifier is an organization unique identifier indicating at least one universally available service that has a universally unique service identifier.

20. (canceled)

21. The method of claim 11, wherein the frame is a data frame that advertises an available service associated with the service identifier, and wherein the apparatus is configured to transfer data according to the service without prior association to a service provider.

22-31. (canceled)

32. An apparatus comprising:
at least one processor; and
at least one memory including a computer program code, wherein the at least one memory and the computer program code are configured, with the at least one processor, to cause the apparatus to:
store at least one service identifier of at least one service;
receive a frame comprising a service identifier of a service in a group address of the frame;
determine, on the basis of the service identifier comprised in the received frame and the stored at least one service identifier whether or not to output contents of the frame to a higher protocol layer.

33. The Apparatus of claim 32, wherein the at least one processor comprises a radio modem and a system processor, wherein said determining is carried out in the radio modem, and wherein the contents of the frame are output from the radio modem to the system processor upon determining to output the contents of the frame to the higher protocol layer.

34. The apparatus of claim 32, wherein the at least one memory and the computer program code are configured, with the at least one processor, to cause the apparatus to discard the contents of the frame upon determining not to output the contents of the frame to the higher layer.

35. The apparatus of claim 32, wherein the apparatus is functioning as a service subscriber or a service publisher in a neighbour awareness networking network, and wherein the at least one service for which the apparatus has stored a service identifier consists of services where the apparatus is the service subscriber or the service publisher.

36. The apparatus of claim 32, wherein the frame is a data frame, and wherein the group address comprises a medium access control field.

37. The apparatus of claim 36, wherein the service identifier is a part of a medium access control address of the frame.

38. The apparatus of claim 32, wherein the group address comprises an application-specific part indicating characteristics of the service.

39. The apparatus of claim 32, wherein the group address comprises a service identifier part for the service identifier.

40. The apparatus of claim 32, wherein the service identifier is an organization unique identifier indicating at least one universally available service that has a universally unique service identifier.

41. (canceled)

42. The apparatus of claim 32, wherein the frame is a data frame that advertises an available service associated with the service identifier, and wherein the at least one memory and the computer program code are configured, with the at least one processor, to cause the apparatus to transfer data according to the service without prior association to a service provider.

43-46. (canceled)
